(19) United States
(12) Patent Application Publication
(10) Pub. No.: US 2012/0191566 A1
(43) Pub. Date: Jul. 26, 2012

(54) PRODUCT INFORMATION, VENDOR REFERRAL, AND PURCHASE BASED ON SCANNED INDICIA

(76) Inventor: Eugene Sayan, Massapequa, NY (US)

(21) Appl. No.: 13/275,984

(22) Filed: Oct. 18, 2011

Related U.S. Application Data
(60) Provisional application No. 61/434,759, filed on Jan. 20, 2011.
(60) Provisional application No. 61/437,452, filed on Jan. 28, 2011.
(60) Provisional application No. 61/548,325, filed on Oct. 18, 2011.

(51) Int. Cl. G06Q 30/00

(52) U.S. Cl. 705/26.8; 705/26.9; 705/26.1

(57) ABSTRACT

A method for providing vendor information to a consumer includes scanning, by a mobile device, an indicia to retrieve a product identifier, sending, by the mobile device, a first message including a location of the mobile device and the product identifier to a computer server remote from the mobile device, determining, by the computer server, a vendor from a list of vendors that supply a product associated with the product identifier and whose location corresponds with the location of the mobile device in response to the first message, and sending, by the computer server, a second message including vendor information of the determined vendor to the mobile device.

### CROSS-REFERENCE TO RELATED APPLICATIONS

This application claims priority to U.S. Provisional Application No. 61/434,759 filed on Jan. 20, 2011, and U.S. Provisional Application No. 61/437,452 filed on Jan. 28, 2011, and U.S. Provisional Application No. 61/548,325 filed on Oct. 18, 2011, the disclosure of each is incorporated by reference herein.

### BACKGROUND

1. Technical Field

The present disclosure relates generally to product information, vendor referral, and purchase based on scanned indicia, and more particularly to product information, vendor referral, and purchase based on scans of indicia by mobile devices.

2. Discussion of Related Art

Mobile Commerce, also known as M-Commerce or mCommerce, is the ability to conduct commerce using a mobile device, such as a mobile phone, a Personal digital assistant (“PDA”), a Smartphone, a Tablet Personal Computer (“PC”), or other emerging mobile equipment such as Dashtop mobile devices. A Smartphone combines the functions of a PDA and a mobile phone, and includes a mobile operating system (“OS”) such as Android™ OS, Iphone™ OS, Blackberry™ OS, etc. A Tablet PC is a tablet-sized computer that has several features of a full-size PC and may also include a mobile OS. Examples of Tablet PCs include the iPAD™, the Samsung Galaxy Tab™, the PlayBook™, etc. Dashtop mobile devices refer to wireless mobile devices mounted on the dashboard of a vehicle.

Recently, brick and mortar business owners and big-box retailers have made an effort to take advantage of mobile commerce by utilizing a number of mobile capabilities such as location based services, barcode scanning, and push notifications to improve the customer experience of shopping in physical stores. By creating what is referred to as a ‘bricks & clicks’ environment, physical retailers (bricks) enable customers to access the common benefits of shopping online (such as product reviews, information, and coupons) while still shopping in the physical store.

A matrix code, also termed a two-dimensional (“2D”) barcode is a 2D way to represent information. It is similar to a linear 1D barcode, but can represent more data per unit area. A Quick Response (“QR”) code is an example of the matrix code. QR codes are now seen in advertisements and can be labeled on goods. A barcode scanner can be used to scan the QR code and interpret the embedded information. Due to the incorporation of cameras into mobile devices, a mobile device can function like a barcode scanner to scan the QR code and interpret the embedded information, and the display of the mobile device can be used to display the information to a consumer.

### SUMMARY

According to an exemplary embodiment of the invention, a method for providing vendor information to a user includes scanning, an indicia by a mobile device to retrieve a product identifier and sending, by the mobile device, a first message including a location of the mobile device and the product identifier to a computer server remote from the mobile device, determining, by the computer server, a vendor from a list of vendors that supply a product associated with the product identifier and whose location corresponds with the location of the mobile device in response to the first message, and sending, by the computer server, a second message including vendor information of the determined vendor to the mobile device.

According to another exemplary embodiment of the invention, a method for providing vendor information includes recording, by a server, a data record including vendor contact information and a vendor location of at least one vendor that provides a product corresponding to a product identifier, scanning, by a consumer device, a product tag encoding the product identifier to retrieve the product identifier, sending, by the consumer device, a first message including the product identifier to the server, wherein the first message comprises consumer information comprising a consumer location of the consumer device, sending, by the server, a second message to the consumer device including the vendor contact information whose vendor locations correspond to the consumer location, and sending, by the server, a third message to a supplier device including the consumer information. The consumer and supplier devices are remote from the server.

According to still another exemplary embodiment of the invention, an m-commerce system includes a computer server having a database and a mobile device having a mobile application to scan indicia and retrieve a product identifier within the scanned indicia and send a first message including the product identifier and a location of the device to the computer server. The database stores product identifiers of products carried by a plurality of vendors and vendor locations of the vendors. An application of the computer server is configured generate a list of the vendors that carry a product associated with the received product identifier and whose vendor locations correspond with the location of the device, and send a second message to the mobile device that includes the list.

According to an exemplary embodiment of the invention, a computer server for recordation and exchange of information includes a memory storing an interface application, a consumer application, and product information, a processor configured to execute the interface application, and a network adaptor configured to communicate over an electronic network. The interface application maintains a first portal for communicating with a supplier application executing on an external supplier device and a second portal for communicating with the consumer application executing on an external consumer mobile device.

The interface application may download the consumer application to the consumer device via the network in response to a scan of an indicia by the consumer device. The interface application records user information from a message including indicia information received by the consumer application via the second portal. The message is sent in response to a subsequent scan of indicia by the consumer mobile device. The interface application sends the user information to the supplier application via the first portal in response to receipt of the message. The interface application then sends the product information to the consumer application via the second portal in response to receipt of the message.

According to another exemplary embodiment of the invention, a method for purchasing a product includes a mobile consumer device scanning a product tag to retrieve a product identifier, the mobile consumer device sending a first message to a server including the first the product identifier and consumer information, the server sending a second message including the product identifier and billing information from the consumer information to a supplier device to initiate a purchase of a product associated with the product identifier, and the server sending a third message to the consumer device that acknowledges a purchase of the product. The consumer and supplier devices are remote from the server.

According to another exemplary embodiment of the invention a server for recordation and exchange of information includes a memory, a processor, a network adaptor, a first portal, and a second portal. The memory stores an interface application and a database formatted to store a record comprising a product identifier and a location. The processor is configured to execute the interface application. The network adaptor is configured to communicate over an electronic network. The first portal is maintained by the interface application and is configured to communicate with a supplier application executing on an external supplier device. The second portal is maintained by the interface application and is configured to communicate with a consumer application executing on an external consumer mobile device. The interface application stores the product identifier and the location in the record in response to a message received via the second portal that includes the product identifier and the location. The interface application sends information of the record to the supplier application via the first portal.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system diagram of devices interfacing with a cloud computing platform.

FIG. 2 illustrates a diagram of supplier devices and consumer devices interfacing with a cloud computer according to an exemplary embodiment of the invention.

FIG. 3 illustrates a computer server of the cloud computer according to an exemplary embodiment of the invention.

FIG. 4 illustrates software services provided by the computer server according to an exemplary embodiment of the invention.

FIG. 5A illustrates a method of interfacing with the computer server according to an exemplary embodiment of the invention.

FIG. 5B illustrates a method of providing vendor information to a user according to an exemplary embodiment of the invention.

FIG. 5C illustrates a method of purchasing a product according an exemplary embodiment of the invention.

FIG. 6 illustrates a process flow diagram of interactions between supplier and consumer devices, and the computer server according to an exemplary embodiment of the invention;

FIG. 7 illustrates an example of a screen that may be presented by an application of the supplier or consumer devices according to an exemplary embodiment of the invention.

FIG. 8 illustrates another example of a screen that may be presented by the application according to an exemplary embodiment of the invention.

### DETAILED DESCRIPTION

It is understood in advance that although this disclosure includes a detailed description on cloud computing, implementations of the teachings recited herein are not limited to a cloud computing environment. Rather, embodiments of the present invention are capable of being implemented in conjunction with any other type of computing environment now known or to be later developed.

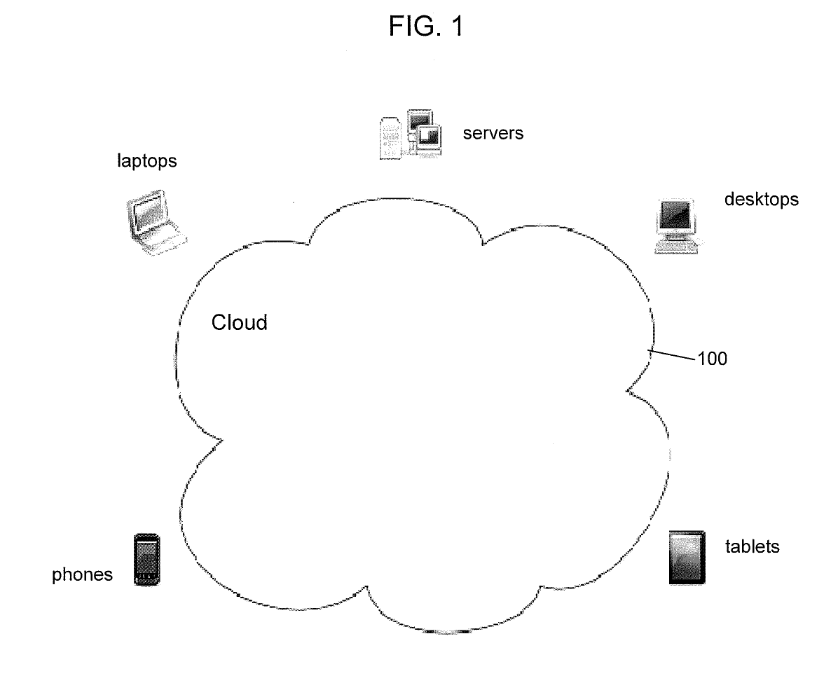

FIG. 1 illustrates a general diagram of a various devices such as laptops, servers, desktop computers, tablet computers, and smart-phones receiving cloud computing services from the cloud 100. Cloud computing is the delivery of computing as a service rather than a product, whereby shared resources, software and information are provided to computers and other devices over a network (e.g., typically the Internet). Cloud computing provides computation, software, data access, and storage services that do not require end-user knowledge of the physical location and configuration of the system that delivers the services.

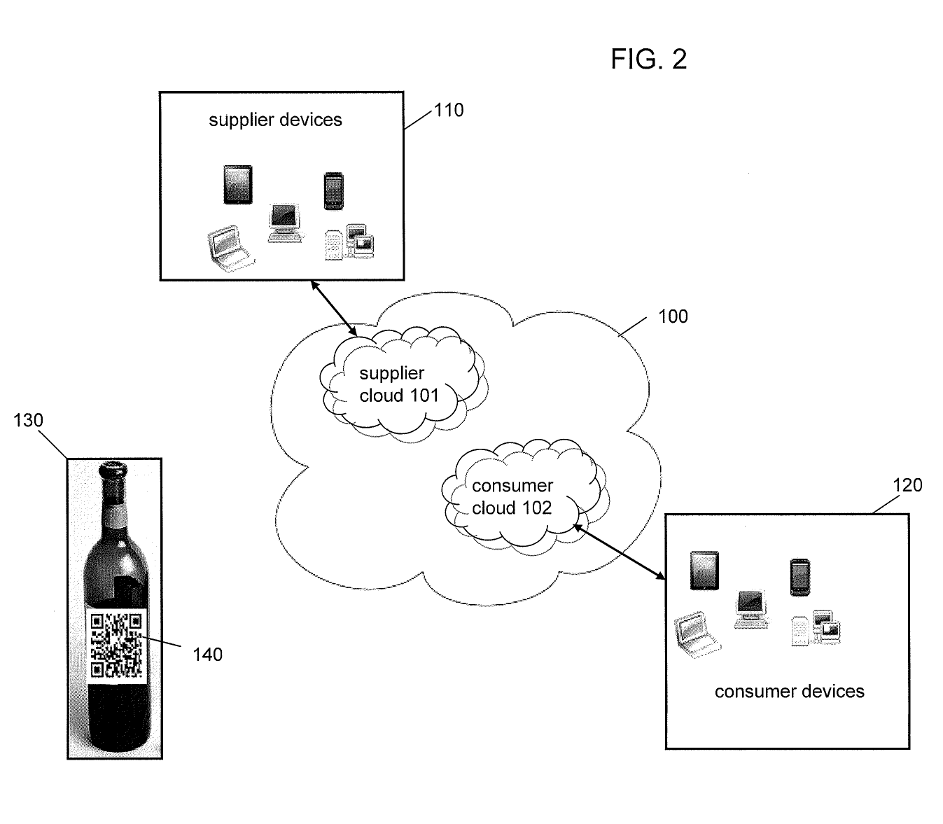

FIG. 2 illustrates a commerce system according to an exemplary embodiment of the invention. The devices of FIG. 1 are divided into supplier devices 110 and consumer devices 120 and the cloud 100 includes a supplier cloud 101 that interfaces with the supplier devices 110 and a consumer cloud 102 that interfaces with the consumer devices. The supplier devices 110 or the consumer devices 110 include software and hardware to scan product tags 140 (e.g., indicia) of one or more products 130. The software and hardware will be discussed in more detail below. In the example shown in FIG. 2, the product tag is a two dimensional barcode (e.g., a Quick Response code) and the product is a bottle of wine. However, this is merely one example of the product tag 140 and embodiments of the invention are not limited thereto. For example, other examples of the product tag 140 will be discussed in more detail below. Further, while the product is illustrated as a bottle of wine, embodiments of the invention are not limited thereto. For example, the product tag 140 can be located on a various products.

In at least one embodiment of the invention, the cloud 100 is a hybrid cloud where the supplier cloud 101 is implemented by a private cloud and the consumer cloud 102 is implemented by a public cloud. In a public cloud, resources are dynamically provisioned to the general public on a fine-grained, self-service basis over a network via web applications/web services, from an off-site third-party provider. In a private cloud, these services are only provided to a single organization or a select group. Commerce related information is exchanged between the cloud 100 and the supplier devices 110 and between the cloud 100 and the consumer devices 120.

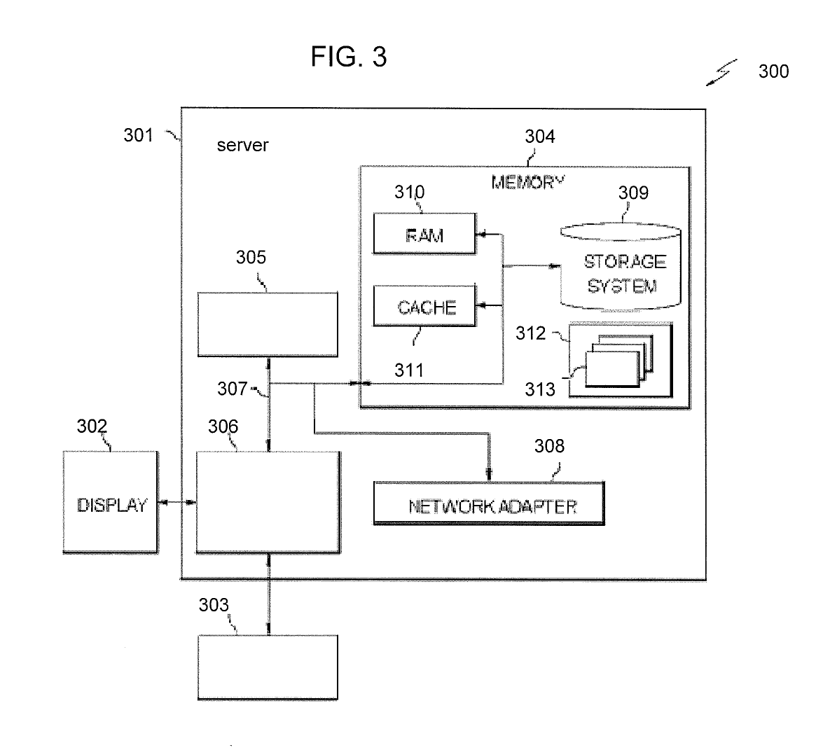

The cloud 100 is supported by a cloud computing infrastructure, which may include a single cloud computing node or a network of interconnected cloud computing nodes. Referring to FIG. 3, a schematic of an example of a cloud computing node is shown. Cloud computing node 300 is only one example of a suitable cloud computing node and is not intended to suggest any limitation as to the scope of use or functionality of embodiments of the invention described herein.

Referring to FIG. 3, the cloud computing node 300 includes a computer server 301, which may operate with numerous other general purpose or special purpose computing system environments or configurations. Examples of well-known computing systems, environments, and/or configurations that may be suitable for use with the computer server 301 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments.

The components of computer server 301 may include, but are not limited to, one or more processors or processing units 305, a system memory 304, and a bus 307 that couples various system components including system memory 304 to processor 305. The bus 307 represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer server 301 may include a variety of computer system readable media. Such media may be any available media that is accessible by computer server 301, and it includes both volatile and non-volatile media, removable and non-removable media. The system memory 304 may include computer system readable media in the form of volatile memory, such as random access memory (RAM) 310 and/or cache memory 311. The computer server 301 may further include other removable/non-removable, volatile/non-volatile computer system storage media. By way of example, storage system 309 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 307 by one or more data media interfaces. The system memory 304 may include at least one program product having a set (e.g., at least one) of program modules that are configured to carry out the functions of embodiments of the invention. The memory 304 may also include a relational database for storing structured data.

A computer program 312, having one or more program modules 313, may be stored in memory 304, as well as an operating system, one or more application programs, other program modules, and program data. Each of the operating system, one or more application programs, other program modules, and program data or some combination thereof, may include an implementation of a networking environment. The program modules 313 may carry out the functions and/or methodologies of embodiments of the invention as described herein.

The computer server 301 may also communicate with one or more external devices 303 such as a keyboard, a pointing device, a display 302, etc.; one or more devices that enable a user to interact with server 301; and/or any devices (e.g., network card, modem, etc.) that enable the computer server 301 to communicate with one or more other computing devices. Such communication can occur via Input/Output (I/O) interfaces 306. The computer server 301 may communicate with one or more networks such as a local area network (LAN), a general wide area network (WAN), and/or a public network (e.g., the Internet) via network adapter 308. As depicted, network adapter 308 communicates with the other components of computer server 301 via bus 307. It should be understood that although not shown, other hardware and/or software components could be used in conjunction with computer server 301. Examples, include, but are not limited to: microcode, device drivers, redundant processing units, external disk drive arrays, RAID systems, tape drives, and data archival storage systems, etc.

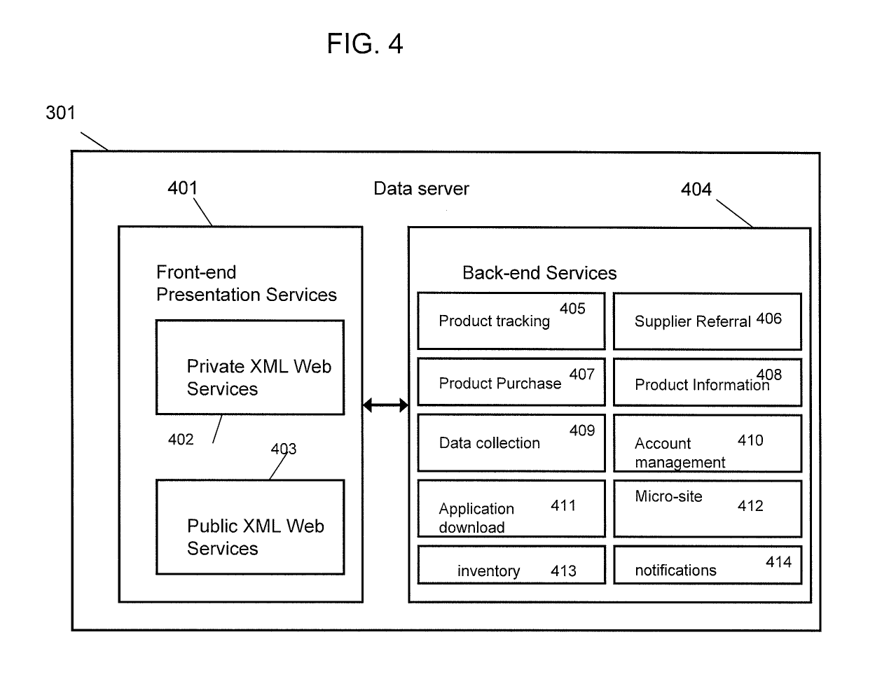

FIG. 4 illustrates software services that may be provided by the computer server 301. The software services may be stored within program 312 or within the program modules 313. The computer server 301 includes a front-end application 401 and a back-end application 404. The front-end application 401 interfaces with an application of the supplier devices 110 and the consumer devices 120, and forwards requests from these devices to the back-end application 404. The computer server 301 can maintain dedicated portals for communicating with the supplier devices 110 and the consumer devices 120. The application on the supplier devices 110 (hereinafter referred to as the “supplier application”) is able to communicate with the computer server 301 through the supplier cloud 101 via a first portal maintained by the computer server 301. The application on the consumer devices 120 (hereinafter referred to as the “consumer application”) is able to communicate with the computer server 301 through the consumer cloud 102 via a second portal maintained by the computer server 301 that is distinct from the first portal.

The front-end application 401 may communicate with the supplier and consumer applications using a Simple Object Access Protocol (“SOAP), which is a protocol specification for exchanging structured information in the implementation of Web Services in computer networks. Soap relies on Extensible Markup Language (XML) for its message format, and may rely on other Application Layer protocols (e.g., Hypertext Transfer Protocol (HTTP) and Simple Mail Transfer Protocol (SMTP)) for message negotiation and transmission. SOAP can form the foundation layer of a web services protocol stack, providing a basic messaging framework upon which web services can be built. This XML based protocol consists of three parts: an envelope, which defines what is in the message and how to process it, a set of encoding rules for expressing instances of application-defined data types, and a convention for representing procedure calls and responses. For example, the front end application 401 includes XML Web Services, which provide Private XML Web Services 402 and Public XML Web Services 403. The front-end application 401 can use the Private XML Web Services 402 to communicate with the supplier application via the first portal (e.g., the supplier cloud 101) and the Public XML Web Services 403 to communicate with the consumer application via the second portal (e.g., the consumer cloud 102). For example, in an exemplary embodiment of the invention, messages received from the supplier devices 110 are processed by the Private XML Web Services 402 and messages received by the consumer devices 120 are processed by the Public XML Web Services 403. In an alternate embodiment of the invention, messages received by the supplier devices 110 are handled by the Private Web Services 402 or the Public XML Web Services 403 (e.g., via the first or second portals) and messages received by the consumer device 120 are only handled by the Public XML Web Services 403.

The supplier application may store a port address and a password, and use the stored port address and/or password to access the Private XML Web Services 402. The consumer application (or the supplier application) may store a port address, and use the stored port address to access the Public XML Web Services 403 without a password.

As discussed above, the front-end application 401 can forward requests from the supplier and the consumer application to the back-end application 404 for various services. The back-end application 404 may provide various services such as a product tracking service 405, a supplier referral service 406 (also known as vendor referral), a product purchase service 407, a product information service 408, a data collection service 409, an account management service 410, an application download/update service 411, a micro-site service 412, an inventory service 413, a notification service 414, etc. The back-end application 404 may provide additional services or fewer than the above-described services. While each service is shown as being in a separate service modules, one or more of these services may be provided in a single module.

The services provided by the back-end application 404 may store data generated as a result of use the corresponding service in a database in the memory 304 or within an external database that is accessible to the computer server 301. Although not shown in FIG. 4, the computer server 301 may include one or more firewalls to prevent unauthorized access to the data stored therein.

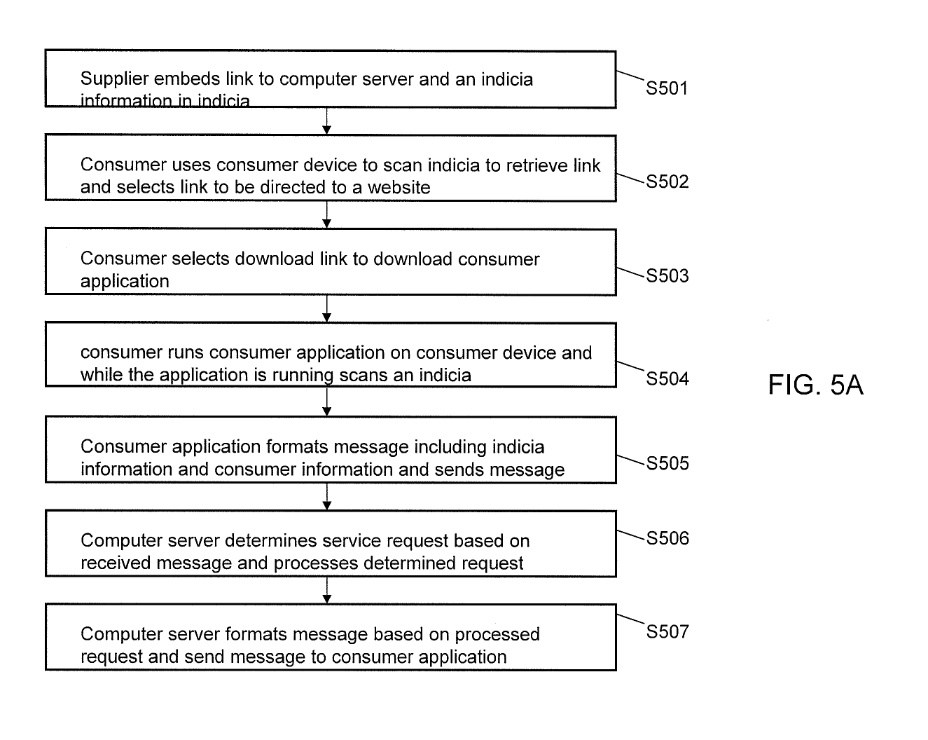

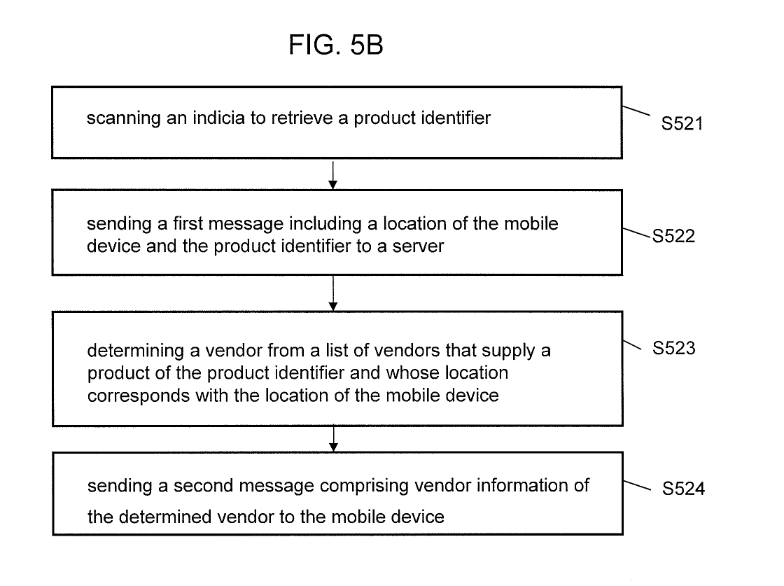

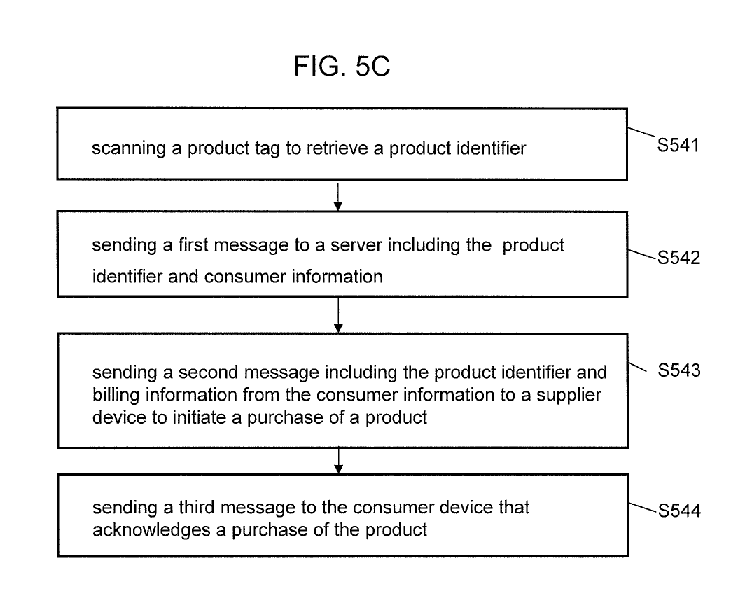

FIG. 5A illustrates a method for providing information to a consumer device 120 using the above-described computer server 301. The consumer device 120 may be one of various devices such as a laptop computer, a desktop computer, a smart-phone, a PDA, a tablet computer, etc. Referring to FIG. 5A, a supplier (e.g., a manufacturer, a wholesaler, a retailer, etc.) embeds a link to the computer server 301 and indicia information (e.g., a product identifier, a tracking code) in an indicia (S501). The indicia may be affixed to or embedded within a product, a physical advertisement (e.g., a newspaper, magazine, a billboard), an electronic advertisement (e.g., displayed in a television commercial). The indicia is any encoding unit such as a barcode or a radio frequency RF tag. The barcode can be a 1-D barcode or a 2-D barcode such as a Quick Response (“QR”) code (e.g., see product tag 140 in FIG. 2). For example, the link may be a first data field in the QR code and the indicia information may be located in a second data field in the QR code. However, bar-code versions of the indicia are not limited to use of QR codes as various other matrix barcodes may be used.

When the indicia is a barcode, the consumer device 120 includes a scanning device such as a 1D barcode scanner, a 2D barcode scanner, or a camera to capture an image of the barcode, and the device 120 has the requisite software to interpret and decode data from the captured image.

When the indicia is an RF tag, the consumer device 120 includes a scanning device such as an RFID reader or an NFC reader, which can apply an appropriate RF field to the tag. The RF tag may be an RF identification (“RFID) tag or a near field communication (“NFC”) tag. For example, application of an RF field by an RFID or NFC reader of the consumer device 120 causes the tag to output a signal including the link and the indicia information. Further, the consumer device 120 has the requisite software to interpret and decode data from the output signal.

The consumer device 120 may include a modem (e.g., a cellular modem) that enables the software of the device 120 (e.g., a Web browser) to access the interne. The supplier devices 110 may have a similar configuration to the consumer device 120.

A consumer uses the consumer device 120 to scan the indicia to retrieve the link and then selects the link to be directed to a website or a landing page (S502). For example software of the consumer device 120 can cause a web browser of the device 120 to be directed to the website. In at least one embodiment of the invention, the website is managed by the computer server 301. The website provides a download link that is selected by the user of the consumer device 120 to download the consumer application (S503). When the website is managed by the computer server 301, in at least one embodiment of the invention, the application download services 411 of the back-end application 404 provides the consumer application to the consumer device 120 via web services of the front-end application 401. The server 301 can use the wireless application protocol (“WAP”) to send the consumer application to the consumer device 120. In an alternate embodiment of the invention, selection of the link embedded within the indicia causes the consumer application to send a message to the computer server 301. In response to the message, the application download services 411 of the back-end application 404 sends a WAP push (e.g., a specially encoded message that includes a link to a WAP address) to the consumer device 120. Upon receiving the WAP push, the consumer device 120 gives the user an option to download the consumer application from the computer server 301.

Upon receipt of the consumer application, the user of the consumer device 120 runs the consumer application and scans the indicia (S504). The indicia may be the same indicia that was initially scanned by the consumer device 120 or a different indicia with similar information. The indicia information may be encrypted such that it is only decodable by the consumer application. For example, when a device without the consumer application scans the indicia with the encrypted indicia information, that device can only interpret the link to download the consumer application, but cannot interpret the indicia information. The consumer application decodes or decrypts the indicia information and formats a message including the decoded or decrypted indicia information and consumer information (hereinafter referred to as the “consumer message”) and sends the consumer message to the computer server 301 via the consumer cloud 102 (S505). The indicia information may include a product identifier and/or a tracking code. The indicia information will be discussed in greater detail below.

The consumer information may include consumer identifying information (e.g., a location of the device, a device identifier, consumer name, a user name, etc.), payment information (e.g., credit card numbers, billing name, billing address, etc.), contact information (mailing address, email address, phone number, instant message user id, social network user id, etc.) and demographic information (e.g., gender, age, salary range, interests, etc.). The consumer application may include an interface that allows the user to enter the identifying, demographic, payment, and contact information. The consumer application may also be configured to extract this information from other programs on the consumer device. The consumer application may query the user for their permission before accessing this information.

The consumer device 120 has location based services to determine its location. The location based services may include a global positioning system (“GPS”) positioning or global system for mobile communications (“GSM”) that determines or approximates the location (e.g., a geographic latitude and longitude) of the device at or about a time of the scan. For example, when the consumer device 120 includes the GPS, it can determine its location from GPS signals received from satellites. GSM is based on signal strength with respect to nearby antenna masts. For example, the location may be determined via multilateration of radio signals between (several) radio towers of a network (e.g., a cellular network) and the consumer device 120. As discussed above, the consumer device 120 may include a cellular modem to transmit the radio signals. To determine the location using multilateration of radio signals, the device 120 can emit at least a roaming signal to contact a next nearby antenna tower, but it may also use signals it emits during active calls. The supplier device 110 may have the same location based services as the consumer device 120.

The computer server 301 (e.g., the front-end application 401) determines a particular service request based on the message received from the consumer application and forwards the determined request to the appropriate service for processing (S506). For example, if the request is for product tracking, the product tracking service 405 processes the request, if the request is for vendor information, the supplier referral service 406 processes the request, if the requesting is for product purchase, the product purchase service 407 processes the request, and if the request is for product information, the product information service 408 processes the request. The computer server 301 then formats a message based on the processed request and sends the message to the consumer application (S507).

As discussed above, the request from the consumer device 120 may be for vendor information. FIG. 5B is a method that illustrates how the request for vendor information is initiated by the consumer device 120 and responded to by the computer server 301 according to an exemplary embodiment of the invention. Referring to FIG. 5B, the method includes a mobile device (e.g., the consumer device 120) scanning an indicia to retrieve a product identifier (e.g., the indicia information) (S521), the mobile device sending a first message including a location of the mobile device and the product identifier to a server (e.g., server 301) remote from the mobile device (S522), the server determines a vendor from a list of vendors that supply a product associated with the product identifier and whose location corresponds with the location of the mobile device in response to the first message (S523), and the server sends a second message comprising vendor information of the determined vendor to the mobile device (S524). The first message may also include the above-described consumer information.

As discussed above, the request from the consumer device 120 may be for a product purchase. FIG. 5C is a method that illustrates how the request for product purchase is initiated by the consumer device and responded to by the server 301. Referring to FIG. 5C, the method includes a mobile consumer device scanning a product tag to retrieve a product identifier (e.g., indicia information) (S541), the mobile consumer device sending a first message to a server including the product identifier and consumer information (S542), the server sending a second message including the product identifier and billing information from the consumer information to a supplier device to initiate a purchase of a product associated with the product identifier (S543), and the server sending a third message to the consumer device that acknowledges a purchase of the product (S544).

The computer server 301 can directly forward consumer information, location information, and indicia information received from the consumer device 120 to the data collection services 409 or the other back-end services may forward data based on the received consumer information and indicia information to the data collection services 409. The data collection service 409 enables the computer server 301 to collect information on users, which may be used by the other services to improve the experience of a consumer. For example, assume the product purchase service 407 has purchased a number of products for users ranging in age from 18-25. This information can be stored by the data collection services 409. Then, the next time a purchase is made by the purchase service 407 by a user in that same age range, the data collection service 409 can recommend to the user one of the other products that are typically purchased by users in that age range. For example, the computer server 301 can send a message to the consumer device 120 including information about the recommended product or an ability to automatically purchase the recommended product. In another example, the data collection service 409 maintains profiles on users based on their scans. For example, a profile may include user identifying information that is extracted from the consumer device 120 by the consumer application (e.g., device identifier, user name, etc.), a list all product identifiers scanned by the device, the time and location of the corresponding scan, products purchased as a result of the scan, etc.

The data collection service 409 can generate statistics on individual users or groups of users in response to the scanned indicia. For example, the statistics could indicate that 20% of males ranging in age 18-25 purchase one soft drink while the remaining 80% purchase a second soft drink.

The computer server 301 can make the statistics and/or information of the profiles available to subscribed users (e.g., manufacturers, vendors, etc.). For example, the accounts management service 410 can maintain accounts for the subscribed users to access these statistics. The server 301 can automatically send the statistics and/or information to a supplier device 110 or upon request by the supplier device 110.

In an exemplary embodiment of the invention, the consumer application queries the user to enter contact information (e.g., email address, phone number, instant message user id, social network user id, etc.) of other individuals that may be interested in downloading the consumer application. Once entered, the consumer application can send a message to the computer server 301 with the contact information, and the server 301 will send a message including the above described download link to the other individuals using the entered contact information.

As discussed above, the supplier device 110 may have hardware that is similar or the same as the consumer device 120. The supplier application may be downloaded to the supplier device 110 in a similar manner to that of the consumer application. For example, the supplier device 110 can scan indicia to retrieve a link that is selected by the user for downloading the supplier application. The computer server 301 can facilitate the download of the supplier application as opposed to the consumer application by identifying the supplier device 110. For example, the computer server 301 can store a list of supplier locations or device identifiers of known supplier devices, and when the download link is selected by a device having one of these known supplier locations or device identifiers, the computer server 301 sends the supplier application to the supplier device 110. When the supplier application is run, similar to the consumer application, a subsequent scan by the supplier device 110 of the indicia sends a message to the computer server 301 (e.g., hereinafter referred to as the “supplier message”).

The supplier message may be sent via the supplier cloud 101. The supplier message may include indicia information of the scanned indicia and supplier information (e.g., the location of the supplier device 110, a device identifier of the supplier device 110, etc.). The back-end application 404 of the computer server 301 can processes service requests in response to the supplier message, format messages based on the processed requests, and send these messages to the supplier application.

As discussed above, either the consumer device 120 or the supplier device 110 can scan the indicia and a corresponding application (e.g., consumer application or supplier application, which may be mobile application, hereinafter referred to as the “scanning application”) on the device decodes indicia information from the indicia and formats a message including the indicia information and consumer or supplier information. The indicia information is derived from the indicia. For example, the indicia information may include a product identifier and/or a unique tracking code. The product identifier may be a Stock Keeping Unit (“SKU”) code, a Universal Product Code (“UPC”) (e.g., 12 digits), a European Article Number (“EAN”), a Global Trade Item Number (“GTIN”), an Australian Product Number (“APN”), etc. The unique tracking code is not always present within the indicia. For example, the unique tracking code may be absent from indicia located on non-tracked items (e.g., on advertisements).

The scanning application sends the formatted message (hereinafter referred to as the “request message”) to the computer server 301 (e.g., over a cellular network via the consumer cloud 102 or supplier cloud 101). In response to the request message, the computer server 301 can reply with a message including supplier/vendor information, general product information, product tracking information, purchase acknowledgment information (e.g., hereinafter referred to as the “response message”). The response message can be formatted (filtered) based on whether it was requested by the consumer application or the supplier application, so that the experience is tailored to the needs or permissions of the requesting party. Further, in response to the request message, the computer server 301 can initiate a purchase of a product that corresponds to the product identifier. The scanning application may include a field in the request message indicating the type of information or transaction requested. For example, the scanning application can enable a user to set this field.

Alternately, the computer server 301 may infer the type of information or transaction that is being requested based on the information that is sent in the request message. For example, if the request message includes the product identifier without the tracking code, the computer server 301 can infer that a request for general product information or supplier/vendor information is being made. In an alternate embodiment, the scanning application is only capable of requesting one type of information and the computer server 301 determines this type based on the identity of the scanning application.

When general product information is requested by the scanning application, the computer server 301 includes product information of a product corresponding to the received product identifier in the response message and forwards the response message to the scanning application. The product information may be supplied by the product information services 408 of the back-end application 404. The product information may include a product description, product details (e.g., dimensions, weight, model number, average customer review rank, technical details, etc.), customer reviews, etc. The computer server 301 can filter the product information based on the identity, location, and preferences of the requesting device or application. A supplier device 120 may be privy to more detailed product information than a consumer device 110. For example, the computer server 301 can format the product information such that it includes the information that is considered most useful to a salesman who sells the scanned product, in response to a request message from a supplier device 120. The computer server 301 can omit or emphasize details based on the location of the sending device. For example, if the computer server 301 determines that the location of the consumer device 110 is within a warm climate, it may be programmed to omit the cold climate based features from the product information. The product information may also include information of other products that are related to the product identifier. For example, the data collection services 409 can maintain statistics of products that are typically purchased along with a product corresponding to the product identifier. The computer server 301 can include information of these additional products within the product information sent in the response message.

In response to a request message including a product identifier, the computer server 301 can infer that a request is being made for information on vendors or suppliers that provide a product associated with the product identifier. This request is forwarded to the supplier referral services 406 of the back-end application 404, which formats a response message that includes vendor information of at least one supplier/vendor that supplies a product that corresponds to or relates to the product identifier. The vendor information may include any information relevant to the vendor, such as for instance, vendor names, vendor addresses, vendor contact information (e.g., phone number, email address, etc.), vendor geographic locations, price information for products that the corresponding vendor carries, etc.

The supplier referral services 406 can limit this vendor information to only those vendors having vendor locations that correspond to the location of the requesting device. For example, vendor information of those vendors that carry a product with the received product identifier having a vendor location within a specified distance from the received location can be included within the response message to the consumer application. The specified distance may be pre-defined by the computer server 301 or specified by the consumer application. For example, the consumer application may include a preferred distance or radius in the consumer message in which vendors are to be selected from. The consumer application can display a geographic map based on the location of the consumer device 120 with marks at each vendor location it receives that supplies the scanned product identifier. For example, the map may be centered at the location of the consumer device 120 and selection on each mark can display the corresponding vendor information and/or directions from the location to the vendor.

The supplier referral services 406 may select the vendors from a list of authorized vendors, thereby excluding un-authorized vendors. For example, the computer server 301 can maintain/store authorized lists of vendors for a particular product identifier in a database in memory 304. Each list may correspond to a different geographic region. Each geographic region defines its boundaries. For example, when a geographic region is a circle or a square, the region includes a center location and a radius, and when the region is a rectangle, the region includes opposing corner locations, or a center location and a length and width, etc. When the consumer device 120 sends its location to the computer server 301 in a request message and the location is within one of the geographic regions, the supplier referral services 406 can send the corresponding list of authorized vendors to the consumer device 120. Thus, instead of the computer server 301 sending vendor details to the requesting device on any vendor near the requesting device that carries the product, only vendor details of the authorized vendors are sent. For example, a consumer is more likely to have confidence in the authenticity and quality of products he purchases from an authorized vendor.

The accounts management service 410 of the back-end application 404 can manage/store accounts for users (e.g., manufacturers, vendors) to remotely enter the authorized vendors for each product identifier, and the geographic region in which the corresponding vendor is authorized to sell the corresponding products within. The accounts management service 410 can also manage/store accounts for the authorized vendors. For example, the authorized vendors may use these accounts to remotely enter/update the list of product identifiers they carry and their vendor location. Data associated with the accounts may be stored on a database on the memory 304.

In an alternate embodiment, the computer server 301 can automatically enter/update the vendor information by downloading data from vendor or manufacturer computers or websites. For example, the computer server 301 can automatically update the list of product identifiers for a vendor and the location of the vendor by parsing known vendor websites. The vendor locations and product identifiers may also be entered manually by a local user of the computer server 301 using the external device 303.

As discussed above, the request message may include consumer information. The consumer information may include user contact information (name, mailing address, geographic location, email address, phone number, etc.), demographic information (e.g., gender, age or age range, salary or salary range, interests, etc.), past purchase information, etc. The request message may also include a time/date when the indicia was scanned. The supplier referral services 406 of the back-end application 404 can then format a message including at least one of all or part of the consumer information, a time of scan, the product identifier, the location of the consumer device, and send the message to one or more of the authorized vendors, wholesalers, or the manufacturer. The receiving party can use the user contact information to contact the user of the consumer device 120 to solicit additional business. Further, in at least one embodiment, the receiving party responds to the server 301 with a price of the scanned product or an offer for the product at a particular price. The server 301 can then forward that price or offer to the consumer application of the consumer device 120. The consumer application can display the offer to enable a user to either accept or reject the displayed offer. If the offer is accepted, the consumer application sends a message to the server 301 indicating that the offer has been accepted. The server 301 can forward the message to the party that made the offer or format a new message to the party that indicates the same.

The data collection services 409 of the back-end application 404 can determine the level of interest in the corresponding product based on how often the product identifier is received (scanned) and use the received location and demographic information to determine how the level of interest for the corresponding product varies from one region to another or varies from one demographic group to another (e.g., males 18-25, salaries above 50 k, etc.). The data collection services 409 can store this interest information and grant subscribers remote access to such.

The vendors for a particular product identifier may be filtered based on preferences, which may be included in the request message from the consumer device 120. For example, if the user had previously purchased the scanned product from a certain set of vendors, the consumer application could include information on this set of vendor in the request message and the supplier referral services 406 could limit the vendor information to that set of vendors. For example, the consumer application can include a list of vendor preferences in the request message, which can be used by the supplier referral services 406 to filter the vendors that will be subsequently sent to the consumer device 120. The consumer application can enable a user to select preferred vendors or disliked vendors. For example, when the consumer device 120 receives and displays vendor information based on a scan of an indicia, the consumer application can allow the user to indicate whether he likes or dislikes the displayed vendor(s) to create the vendor preferences. The preferences may include the consumer's preferred distances/radius from which vendors are to be selected. The filtering by preference may be performed either locally by the consumer application on the consumer device 120 or by the server 301. For example, when the consumer application performs this filtering, the preferences are stored within the consumer application.

Since some vendors do not have physical locations (e.g., online stores), the supplier referral services 406 need not take into account the received location of the requesting device when deciding whether to add an online vendor to the list of vendors.

For example, the supplier referral services 406 can format a response message for the consumer device 120 including all authorized online vendors of a particular scanned product and all vendors with physical stores that are within a pre-defined distance from the location of the consumer device.

The product information and vendor information may be stored within micro-sites that are managed by the micro-site management services 412 of the computer server 301. Each micro-site can correspond to a manufacturer, a wholesaler, or vendor/supplier. The account management service 410 can maintain accounts that enable a user to remotely log-on to the computer server 301 make changes to their corresponding micro-site. When one of the listed vendors is selected by a user of the consumer application, the data of the corresponding micro-site can be displayed to the user through the consumer application. Further, instead of the supplier referral service 406 sending a list of authorized vendors to the consumer device 120, the supplier referral service can arbitrarily select one and send the data of its micro-site to the consumer application. This selection can also be made based on the preferences of the consumer application. For example, if the user prefers one authorized vendor over another, the preferred one can be selected. The micro-site can provide product information on a product associated with the product identifier, information of the manufacturer that makes the product, or information about a vendor that supplies the product.

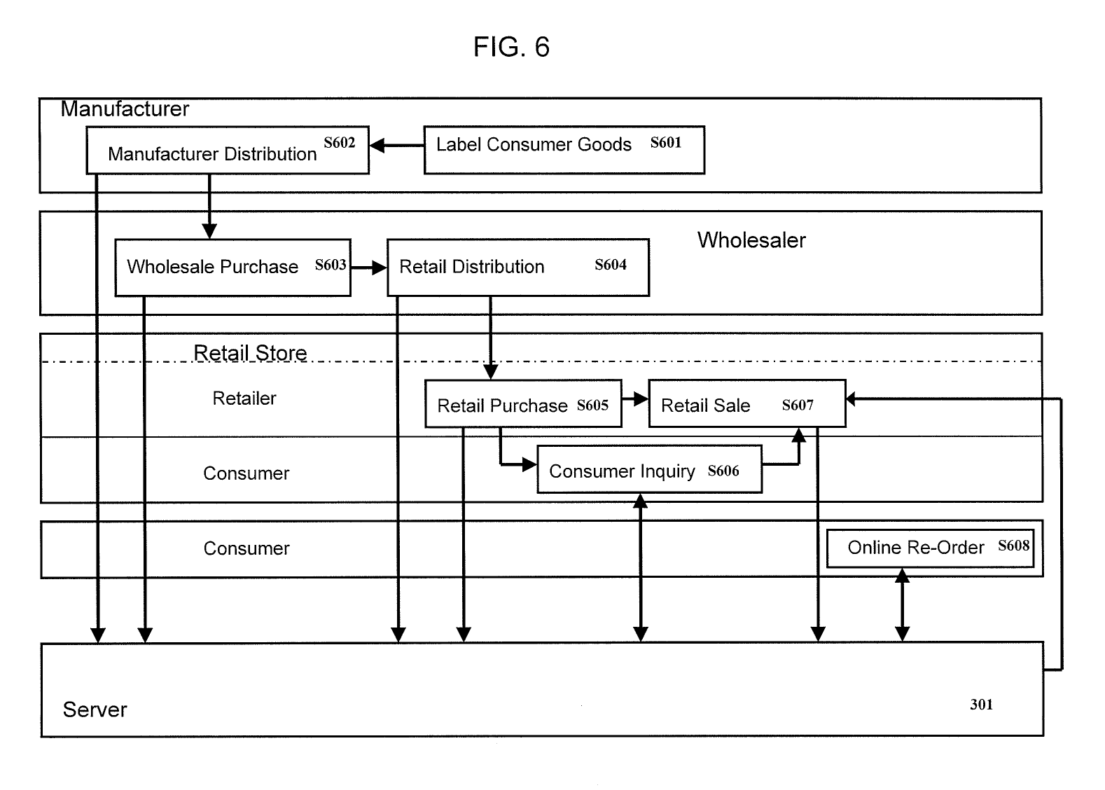

FIG. 6 illustrates an exemplary process flow diagram showing interactions between a manufacturer and the computer server 301, a wholesaler and the computer server 301, a retailer and the computer server 301, and a consumer and the computer server 301 according to an exemplary embodiment of the invention. For ease of discussion, the below assumes that a manufacturer ships units to a wholesaler, the wholesaler ships the units to a retailers, and a consumer purchase the units from the retailers. However, in alternate embodiments, the manufacturer can ship the units directly to the retailers or directly to the consumers.

Prior to distribution of a unit of consumer goods, the manufacturer labels the unit with a product tag (S601). The product tag 140 includes the above described indicia. Then prior to distributing the labeled units, the manufacturer may use the supplier application on the supplier device 110 to scan the product tag 140 of each unit that is scheduled to be shipped to a particular wholesaler, retailer, or consumer (S602). The scanning sends a message to the server 301 that indicates that the unit has been shipped.

A wholesaler can use the supplier application on the supplier device 110 to scan a product tag 140 of a received unit of goods to send a message to the server 301 to either indicate that the unit has been received (S603) or to indicate that the unit of goods has been sold to a retailer or a consumer (S604). Accordingly, the message may include a field that indicates whether the scan is to acknowledge receipt or a sale of the unit, so that the server 301 can distinguish the messages from one another. The supplier application can provide a user interface that enables a user to set this field prior to scanning.

A vendor that receives a shipment of goods from the wholesaler can use the supplier application of a supplier device 110 to scan the product tag 140 of each unit received to send a message to the server 301 that indicates either that the unit has been received (S605) or that the unit has been sold or shipped (S607). The vendor may be a retail store or an online store. The supplier application may enable a user to select between acknowledging receipt of the goods from a party (e.g., from the manufacturer or the wholesaler) and acknowledging sale or shipment of the goods to a party (e.g., to a consumer). Accordingly, the message may include a field that indicates whether the scan is to acknowledge receipt of the goods or a sale/shipment of the goods.

A consumer can use a consumer device 120 device including the above-described consumer application to scan the product tag 140 of a unit of goods located at the retailer (e.g., in a physical retail store) (S606). In response to the scan of the product tag 140, the consumer application can send the consumer message to the server 301 (e.g., via the consumer cloud 102) including the above-described consumer information. As discussed above, the data collection services 409 can store information associated with the product that indicates the consumer's interest in the product. Further, the data collection services 409 can store user/consumer information of the consumers that scanned the unit. The user/consumer information in the consumer message can be linked to the unit. For example, the user/consumer information can be stored by the data collection services 409 in a record having the product identifier. As additional consumers scan the unit, their corresponding consumer information can be appended. The server 301 can enable authorized users (e.g., a manufacturer, the wholesaler, retailer, etc.) to access some or part of this consumer information. For example, the server 301 can send a message to the authorized users including the consumer information of those that have scanned their products.

As discussed above, when a consumer uses the consumer device 120 to scan a product tag 140, the consumer application can display product and vendor data from a micro-site that is managed by the computer server 301. The micro-site can provide a shopping experience that is tailored by a manufacturer or a vendor. For example, manufacturers and vendors can log-on to the server 301 and customize their micro-site using tools provided by the micro-site services 412. The server 301 can associate each micro-site with a product identifier of a scanned product tag. For example, multiple micro-sites can provide information on the same product identifier since many vendors can provide the same product. The micro-site may include an overview of the product, its features, specifications, real customer reviews and ratings, service details, videos, etc. Due to the wealth of information provided, the consumer can quickly make an informed decision on the spot, without the need to leave the retail location to do more research on the product or shop at competitors.

The information presented to the consumer can be tailored according to the location of the consumer. For example, if the consumer had scanned the unit in a retail store at a particular mall, along with information on the product, they can be presented with coupons or advertisements for that particular retail store, or other stores in the mall.

When the consumer purchases the unit from within a retail store, the vendor can use the supplier application of a supplier device 110 to scan the unit to send a message to the server 301 to indicate that the unit has been purchased (S607). Before the unit is scanned, the vendor may need to set the device to indicate that subsequent scans are to acknowledge sales. The supplier application can send a message to the server 301 that indicates the unit has been purchased by a consumer. The message may include a field that indicates the unit has been purchased as opposed to being received.

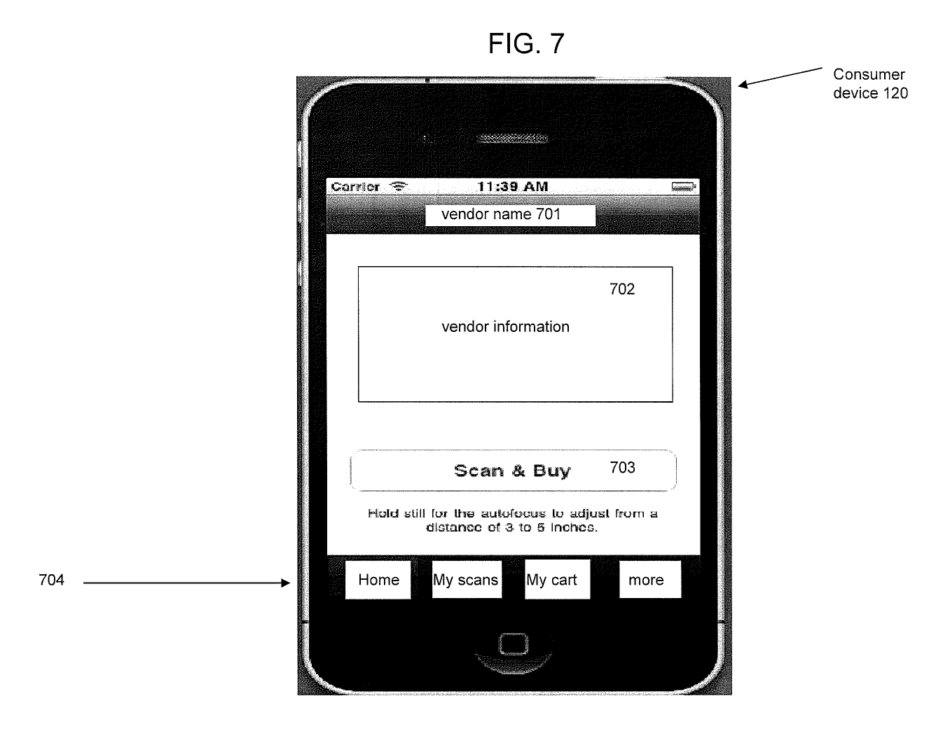

A consumer can also use the consumer device 120 to scan a product tag to purchase a product like the scanned unit or to re-order a product like the scanned (S608). For example, when the product tag is scanned outside of a retail store, the consumer application can present data from one of the above-described micro-sites to the user to enable purchase of the scanned unit or a re-order of a product like the scanned unit. In alternate embodiment, the consumer application uses the personal information of the consumer (e.g., name, address, credit card information) to automatically purchase or re-order (“Buy Now”) the unit or a product like the unit from the original vendor, another vendor/retailer, or directly from the wholesaler or manufacturer. For example, FIG. 7 is an example of a screen that may be presented by the consumer application using data provided by the computer server 301 from the micro-sites it manages. The screen in this example displays the name 701 of a preferred vendor, vendor information 702, a Scan and Buy option 703, and various function selections 704.

When the Scan and Buy option 703 is selected, each product tag subsequently scanned that refers to a product carried by the vendor is automatically purchased using the product purchase service 407 of the back-end application 404. The product purchase service 407 can validate the transaction and interface with a server of the vendor to complete the purchase. The product purchase service 407 may send a purchase authentication message to the consumer device 120. For example, the consumer application may request the consumer enter a password to authorize the purchase in response to the purchase authentication message. The consumer application can then forward the password (encrypted) to the product purchase service 407, which can compare the entered password against a password that is stored for the consumer. The account management service 410 can maintain accounts for the consumers that store their passwords, credit card information, and address billing information to enable the product purchase 407 service to authenticate the password and complete purchases of the scanned items.

The function selections 704 may include various options such as options to enable the consumer to exit the consumer application, view their past scans, share their past scans with others, view a virtual shopping cart, etc.

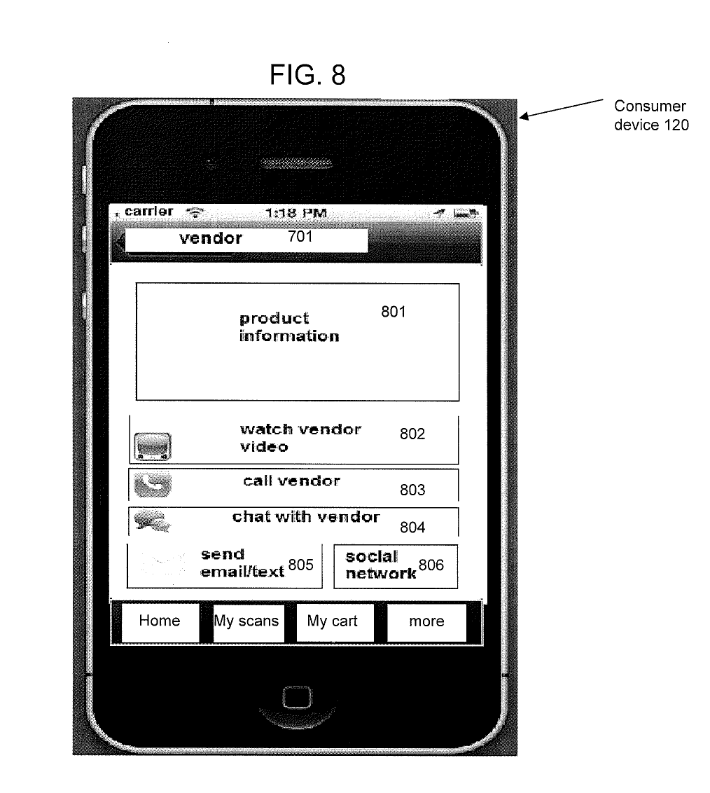

FIG. 8 illustrates an example of a screen that may be presented by the consumer application of the consumer device 120 after the product tag has been scanned. Referring to FIG. 8, the screen includes product information 801, a video link 802 that when selected displays a video, a call link 803 that when selected automatically calls a vendor (e.g., the nearest with respect to the location of the scanner) that sells the scanned product, a chat link 604 that when selected automatically creates a chat session with the vendor, a email link 805 that automatically sends an email to the vendor, and social network links 806 (e.g., Facebook®, Twitter®, Google+®, LinkedIn®, etc.) that when selected allow the user to input their feedback about the product (e.g., indicate to social network they recommend or like the product), follow reports on the product on the social networks, or send a message to a friend.

For example, selection of one of the social network links 806 can post a message on a page of the user's corresponding social network that indicates the user likes the scanned product. The page is visible to others in the social network (e.g., friends of the user). The message may include links to the vendors that provide the scanned product and a download-link to download the consumer application. When other users select the download-link from their mobile device, the consumer application is downloaded to their device. The message may also display the same product tag (e.g., a 2D barcode) that was originally scanned by the initial user. Then, the other users of the social network can use their mobile devices to scan the displayed product tag to download the consumer application or display the product information, if the application is already present.

If the scanned product is to be a gift, the consumer application enables the scanning party to enter user information (e.g., contact information) of the recipient, which is sent to the computer server 301. The consumer application also enables the gifting party to create or upload a personal video to the computer server 301 that becomes associated with the gifted product. The computer server 301 can store the user information of the recipient and then forward a message to the recipient that enables the recipient to play the video or download the consumer application.

When the recipient receives the gifted product, performing a scan of its product tag by their mobile device either causes the consumer application to be downloaded to their mobile device or if the application is already present, the scan may cause the video to be played. For example, the computer server 301 recognizes that the product has been scanned by the recipient of the gift as opposed to some other party based on matching the personal information sent by the consumer application of the party receiving the gift against the personal information it holds for the gifted party.

The consumer application on the device of the party that received the gift may enable the party to send a thank you letter back to the gifting party. For example, the consumer application sends a message to the server 301 that includes a request to send the thank you card to the gifting party and then the server 301 sends the thank you letter (e.g., via email, text message) to the gifting party. The server 301 may also send the thank you letter directly to the consumer application of the gifting party for display by the consumer application on their mobile device.

The consumer application can also allow the user to send a gift a card to friend based on the scanned product. For example, if the scanned product is affiliated with a particular vendor, the consumer application may query the user to purchase a gift card of the vendor for that friend. The consumer application enables the user to associate a video with the gift card. The consumer application queries the user for user information of the recipient of the gift, which is sent to the computer server 301. The gift card may include a gift tag (e.g., 2D barcode, RFID tag, NFC tag, etc) similar to the product tag, where a scan of the gift tag by the recipient using their mobile device either downloads the consumer application or plays the video if the application is already present.

The consumer application can also be used to add the scanned item or a product like the scanned item to a virtual shopping cart, which enables the prior scanned items to be purchased at a later time.

When the consumer device 120 scans a product tag outside of a retail store, the consumer application can also display the above described product information. This product information can be personalized based on the current location of the user. For example, the product information may include a list of vendors within a pre-defined distance of the scanned location that carry the product. Further, as described above, this product information may include tracking information associated with the unit of goods. The consumer application can aggregate data/content from different sources and mediums so that only the right amount of information about the product or the manufacturer is presented. The product information presented by the consumer application may include selectable links to other products that were purchased along with the scanned unit of goods (“other products purchased with this”), other products that were purchased by individuals with similar interests (“people like me”). In this way, the presented product information can influence sales within very specific geographic and demographic groups, as well as small micro-segments.

In a further embodiment, a salesman may use a supplier device 120 that includes a supplier application that enables him to scan the product tags to view information that will aid him in selling the scanned product tag. For example, a list of commonly asked consumer questions and answers about the scanned unit may be presented to the salesman by the supplier application upon scanning the product tag so that he can educate himself prior to speaking with prospective customers. This ensures that sales associates have instant answers and can provide a higher level of customer service. Instead of wearing a blank expression when asked about specific product details, associates can instead access information from the product tags to efficiently serve the customer with confidence to close the sale.

As discussed above, those in the supply chain (e.g., the manufacturer, the wholesaler, vendor/retailer) can use the supplier devices 120 to access the server 301 through the supplier cloud 101 and the consumer can use the consumer device 110 to access the server 301 through the consumer cloud 102. The server 301 can provide separate portals for entry of the supplier devices 120 via the supplier cloud 101 and entry of the consumer devices 110 via the consumer cloud 102. This enables the server 301 to present different types of data to the requesting devices and prevents certain devices from accessing or updating privileged data. For example, the product information of a unit of goods may have details that are only viewable by the supplier and not by the consumers.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

It is to be understood that exemplary embodiments disclosed above are illustrative only, as the invention may be modified and practiced in different but equivalent manners apparent to those skilled in the art having the benefit of the teachings herein. It is therefore evident that exemplary embodiments disclosed herein may be altered or modified and all such variations are considered within the scope and spirit of the invention.

What is claimed:

1. A method for providing vendor information to a user, the method comprising:
scanning, by a mobile device, an indicia to retrieve a product identifier;
sending, by the mobile device, a first message comprising a location of the mobile device and the product identifier to a server remote from the mobile device;
determining, by the server, a vendor from a list of vendors that supply a product associated with the product identifier and whose location corresponds with the location of the mobile device in response to the first message; and
sending, by the server, a second message comprising vendor information of the determined vendor to the mobile device.

2. The method of claim 1, wherein the server maintains lists of authorized vendors, each list corresponding to a distinct geographic region, and the server selects the vendor information from the list whose geographic region encompasses the location of the mobile device.

3. The method of claim 1, wherein the vendor information comprises at least one of a geographic location, a business address, a website address, a phone number, an email address, and a price of the product.

4. The method of claim 1, further comprising, displaying, by the mobile device, a selectable option that initiates an electronic chat, a telephone call, an email, an SMS message, or a social network message based on the received vendor information.

5. The method of claim 1, further comprising, presenting by the mobile device, an option that when selected, purchases the product, displays product information about the product, displays a video, or adds the product to a virtual shopping cart, from a micro-site managed by the server.

6. The method of claim 1, wherein the vendor information comprises a vendor location for the determined vendor, and the method further comprises presenting by an application of the mobile device, a geographic map based on the location of the device indicating the vendor location.

7. The method of claim 1, where in the computer server is part of a cloud computing platform.

8. The method of claim 1, wherein the product identifier is one of a Stock Keeping Unit SKU code, a Universal Product Code UPC, a European Article Number EAN, a Global Trade Item Number GTIN, and an Australian Product Number APN.

9. The method of claim 1, wherein the first message comprises user contact information of a user of the mobile device and the method further comprises sending by the computer server, a third message comprising the product identifier and the user contact information to the determined vendor.

10. The method of claim 1, wherein the first message comprises vendor preferences, and the determining of the vendor comprises filtering out a vendor from the list based on the vendor preferences.

11. The method of claim 10, wherein the mobile device provides an option that enables a user to indicate a like or dislike for the determined vendor and store the indication in the vendor preferences.

12. The method of claim 1, wherein the first message comprises a distance, and the determining of the vendor comprises filtering out a vendor from the list whose location is greater than the distance from the location of the mobile device.

13. The method of claim 1, wherein the indicia is a two dimensional barcode.

14. The method of claim 1, wherein the indicia is a radio frequency identification RFID tag or a near field communication NFC tag.

15. The method of claim 1, wherein the mobile device comprises a location based system that calculates the location at or about a time of the scan using received electromagnetic signals.

16. The method of claim 1, wherein the messages are sent across a wireless network.

17. The method of claim 1, wherein the location based system is one of a global positioning system or a global system for mobile communication.

18. The method of claim 1, wherein the mobile device is a Smartphone, a tablet computer, or a personal digital assistant.

19. The method of claim 1, wherein the mobile device comprises a camera that is configured to scan the indicia.

20. The method of claim 1, wherein the indica comprises an un-encrypted first field and an encrypted second field, the first field comprises a link for downloading an application from the server to the mobile device that performs the scanning and the sending of the first message and the second field comprises the product identifier.

21. A method for purchasing a product, the method comprising:
scanning, by a mobile consumer device, a product tag to retrieve a product identifier;
sending, by the mobile consumer device, a first message to a server, wherein the first message comprises the product identifier and consumer information;
sending, by the server, a second message including the product identifier and billing information from the consumer information, to a supplier device to initiate a purchase of a product associated with the product identifier; and
sending, by the server, a third message to the consumer device that acknowledges a purchase of the product,
wherein the consumer and supplier devices are remote from the server.

22. A server for recordation and exchange of information, the server comprising:
a memory storing an interface application and a database formatted to store a record comprising a product identifier and a location;
a processor configured to execute the interface application;
a network adaptor configured to communicate over an electronic network;
a first portal maintained by the interface application and configured to communicate with a supplier application executing on an external supplier device; and
a second portal maintained by the interface application and configured to communicate with a consumer application executing on an external consumer mobile device,
wherein the interface application stores the product identifier and the location in the record in response to a message received via the second portal that includes the product identifier and the location, and
wherein the interface application sends information of the record to the supplier application via the first portal.

23. The server of claim 22, wherein the consumer application is configured to control the consumer mobile device to scan an indicia to retrieve the product identifier.

24. The server of claim 23, wherein the consumer application includes a time of the scan in the message, and the interface application stores the time in the record.

25. The server of claim 22, wherein the interface application is configured to upload the consumer application to the consumer mobile device upon receiving a download request from the consumer mobile device.

26. The server of claim 23, wherein the consumer application is configured to calculate the location from electromagnetic signals received by the consumer mobile device at or about a time of the scan.

27. The server of claim 23, wherein the consumer application is configured to extract personal user information from the consumer mobile device and include the personal user information in the message.
